(19) United States
(12) Patent Application Publication
(10) Pub. No.: US 2012/0087529 A1
(43) Pub. Date: Apr. 12, 2012

(54) UNDERGROUND SUBWOOFER

(76) Inventors: Jeffrey Coombs, Lake Havasu City, AZ (US); Michael Petroff, Pasadena, CA (US)

(21) Appl. No.: 13/267,418

(22) Filed: Oct. 6, 2011

Related U.S. Application Data
(60) Provisional application No. 61/390,400, filed on Oct. 6, 2010.

(51) Int. Cl. H04R 1/02

(52) U.S. Cl. 381/334

(57) ABSTRACT

An underground subwoofer system in which abrupt disruptions in airflow have been corrected through modifications of the subwoofer system output airway path, thereby substantially reducing sound wave turbulence, while simultaneously undergoing an above ground substantially 180-degree directional change in the sound wave air or airway path. These modifications provide smoothly contiguous cross-sectional area directional transitions in the airway path, and can include variations in the subwoofer system design, the sound wave airway path design, the above ground directional change hood design, and/or a selective combination of the above.

### CROSS REFERENCE TO RELATED APPLICATIONS

This application claims priority from and the benefit of U.S. Provisional Patent Application Ser. No. 61/390,400, filed on Oct. 6, 2010, the entire contents of which, is incorporated herein by reference.

### BACKGROUND

1. Technical Field

The present invention relates to underground speakers. More particularly, it relates to an underground subwoofer.

2. Description of the Prior Art

Referring to FIG. 1, the current designs for underground subwoofers include a cabinet 10 having the subwoofer elements/electronics 12 contained therein. An air passage way or sound wave path 14 carries the sound waves out of the cabinet 10 and up above the ground surface where it is dispersed using a hood like dome 16.

Those of skill in the art will appreciate that in order to provide optimal bass reproduction, and so as to not interfere with the generated sound waves, these sound waves need to travel without sudden interruption. For example, as shown in FIG. 1, the prior art systems include several sharp (i.e., 90 degree) turns 20A, 20B, 20C, 20D through (i.e., around) which the sound waves must travel in order to be released from the cabinet and into the outside air. Thus, in this example, the flow path of the sound waves is not smoothly contiguous (meaning not free of abrupt disruptions), thus resulting in turbulences causing an undesirable whizzing sound or puffing effect, as well as a decrease in subwoofer efficiency.

### SUMMARY

The present invention provides improvements over existing underground subwoofer designs where a contiguous cross-sectional area through directional transitions is achieved. In the preferred implementation, the cross-sectional volume and area from the collimated cylindrical sound wave path to the hood remains constant or in unity with a 1:1 ratio. In this manner, right angles are completely eliminated in the sound wave path such that the flow path is smoothly contiguous (i.e., completely free of abrupt disruptions of any kind).

In one preferred implementation, the cross-sectional area through the transitions varies gradually and gradually increases from the inside of the cabinet toward the outside air (i.e., is expanding).

Other objects and features of the present principles will become apparent from the following detailed description considered in conjunction with the accompanying drawings. It is to be understood, however, that the drawings are designed solely for purposes of illustration and not as a definition of the limits of the present principles, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings wherein like reference numerals denote similar components throughout the views:

FIG. 1 is cross sectional view of an underground subwoofer according to the prior art;

FIG. 2 is a cross-sectional view of an underground subwoofer according to an embodiment of the invention;

FIG. 3 is a cross-sectional view of an underground subwoofer according to another embodiment of the invention;

FIG. 4 is a cross-sectional view of a hood of an underground subwoofer according to an embodiment of the invention;

FIG. 5 is a cross-sectional view of a hood of an underground subwoofer according to an embodiment of the invention;

FIG. 6 is a cross-sectional view of a hood of an underground subwoofer according to an embodiment of the invention;

FIG. 7 is a cross-sectional view of a hood of an underground subwoofer according to an embodiment of the invention;

FIG. 8 is a cross-sectional view of a hood of an underground subwoofer according to an embodiment of the invention;

FIG. 9 is a cross-sectional view of a hood of an underground subwoofer according to an embodiment of the invention;

FIG. 10 is a diagram of an exemplary toroid sound wave as output from the subwoofer assembly according to an embodiment of the invention;

FIG. 11 is a diagram of an exemplary cylindrical sound wave as it travels through the airway of the subwoofer assembly according to an embodiment of the invention; and

FIG. 12 is a diagram showing the desired unity of volume/area achieved in the preferred embodiment of the subwoofer assembly according to the invention.

### DETAILED DESCRIPTION

According to a first embodiment of the invention, the right angle 20A of the prior art cabinet is removed and replaced with a curved surface 22 as shown in FIG. 2. In this manner, the sound waves generated by sub woofer 12 pass along the curved surface 22 into the sound wave path 14 without any abrupt disruption, thereby substantially reducing turbulence and its corresponding negative effect on sound quality and the efficiency of subwoofer 12.

According to another embodiment, shown in FIG. 2, the sound wave path or airway 14 is changed so that in includes curved input surfaces 24 as shown. Here the sound waves shall pass into the airway 14, again, without abrupt disruption.

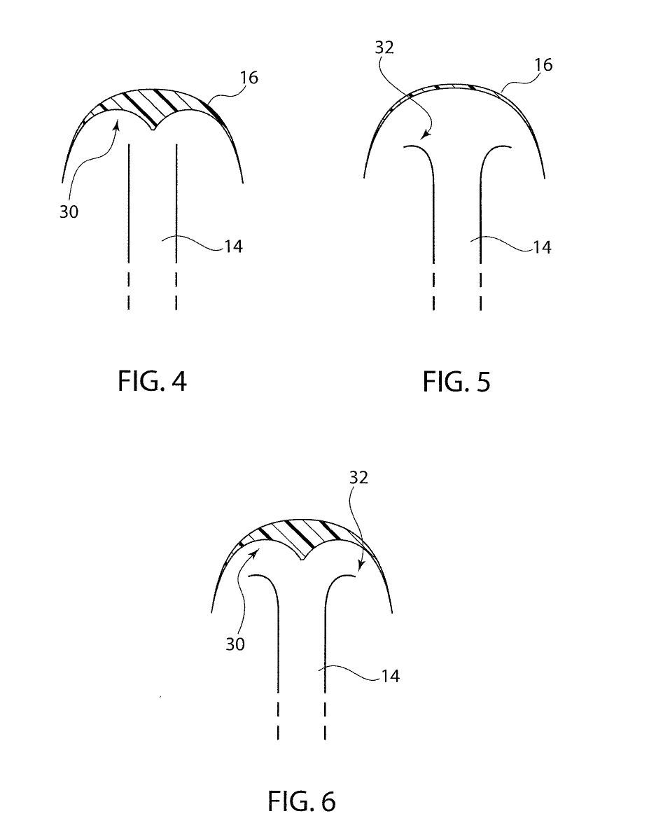

As shown in FIGS. 2 and 3, and throughout this disclosure, the purpose of the present invention is to provide a smoothly contiguous cross sectional area through all transitions of the sound wave path 14. As will be described below with respect to FIGS. 4-9, this contiguous cross-sectional area is provided through a substantially 180 degree directional transition from sound wave path 14 to the output or exit of the sound wave path 14 from hood 16.

In an alternative implementation, the transitions can vary gradually where they increase from sound wave generation within the sub-woofer cabinet (i.e., woofer 12) toward the output above the ground (via hood 16).

FIG. 4 shows an example of the improved hood 16 design according to an implementation of the invention. As shown, the underside of the hood includes rounded internal surfaces 30 which are positioned over the sound wave air path 14 as shown. In this manner, the sound waves are more efficiently and contiguously directed out of the hood 16 by creating two separate paths for the sound waves to pass without abrupt disruption.

Those of skill in the art will appreciate that these cross-sectional views suggest two separate airway paths, but actually the hood converts a cylindrically-shaped input sound wave path (i.e., airway 14) into a single 360-degree donut or toroid-shaped output sound wave, while at the same time undergoing the substantially 180-degrees of directional change from the input to the output sound waves.

According to the preferred implementation of the invention, the cylindrical sound wave (in airway 14) is converted to the toroid shaped sound wave (by hood 16), while maintaining an equal/constant cross-sectional volume during and through the transition or directional change of substantially 180 degrees. Thus, according to a preferred implementation of the invention, a 1:1 ratio is defined between the cross-sectional volume of airway 14, and the cross sectional volume of the transition (i.e., the 180 degree sound wave transition) performed by the hood 16. This constant volume ratio is referred to herein as “unity” of the cross-sectional volume. Furthermore, the term unity may also be used to refer to the constant or equal cross-sectional area of the sound wave traveling through airway 14, and the substantially 180 degree transition provided by hood 16 to produce the toroid or donut shaped output sound wave.

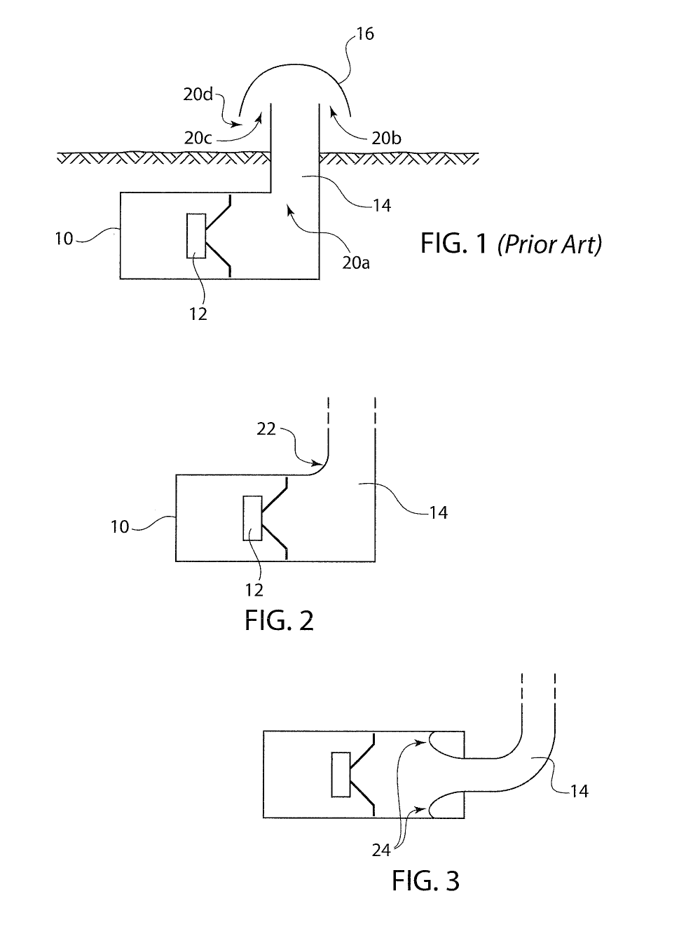

FIG. 5 shows another implementation of the hood 16 where the hood remains unchanged and the top surfaces 32 of the airway 14 are modified to include a radius of curvature, thus eliminating the disruptions 20B, 20C shown in FIG. 1 of the prior art. Again, the above mentioned concept of maintaining the 1:1 ratio of cross-sectional volumes of the airway 14 through the substantially 180 degree transition that the sound wave travels is preferred to provide the enhanced audio effects of the present invention. Those of skill in the art will appreciate that slight modifications in this ratio could be made without departing from the intended scope of the invention. For example, the airway to transition ratio of 1:1 could be changed such that the transition is larger, for example in the order of 1:2, 1:3, 1:4 or even up to 1:5. In this configuration, the increase in cross-sectional volume of the sound wave from the substantially cylindrical airway 14 to the substantially 180 degree transition would be gradually increases such that the output toroid sound wave would have a cross-sectional area and/or volume equal to, for example, anywhere from 1× (i.e. unity) up to 3× the respective airway cross-sectional area and/or volume.

FIG. 6 shows the combination of the rounded surfaces 30 and 32 as shown in FIGS. 4 and 5. Here, the majority of disruptive surfaces over which the sound waves may travel have been eliminated.

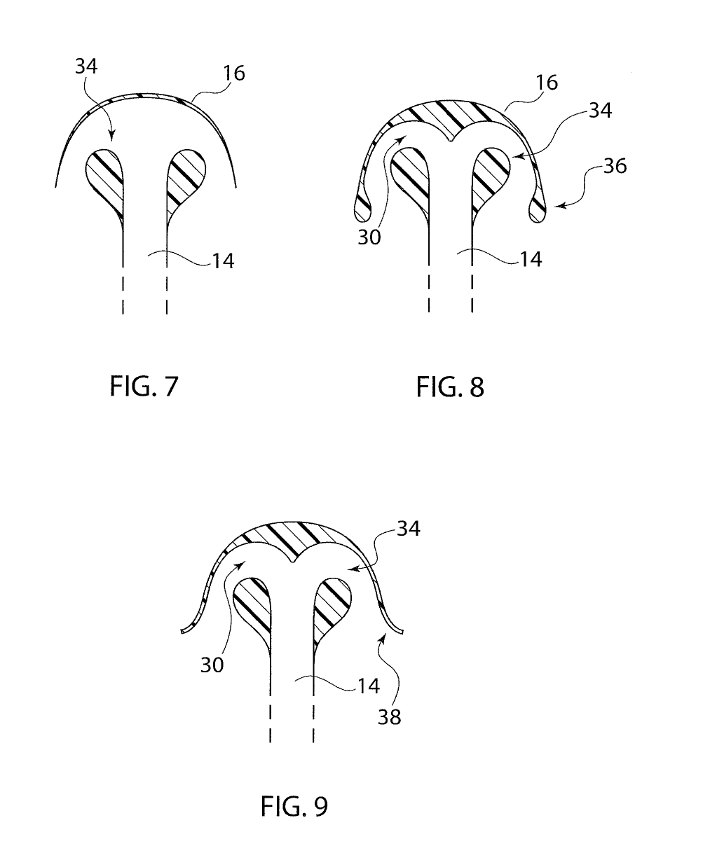

FIG. 7 shows another implementation of the invention where the cross section of the top of the sound wave path 14 is as shown. Here the curvature is not only situated on the top portion of the airway 14 but is continued around the outside of the sound wave path 14 so as to provide the preferred uninterrupted and contiguous airflow of the sound waves from the sub woofer cabinet 10. FIG. 8 shows a first preferred embodiment of the invention, where the hood 16 is modified to include the cross-sectional curvatures 30 at the top inside surface, and to include the curvatures 36 at the output of the hood 16. In addition, the top of the sound wave path 14 is modified to include the curvatures 34. In this preferred implementation, all known disruption points (e.g., 20A, 20B, 20C and 20D shown in FIG. 1) are eliminated and the sound waves can travel without abrupt disruptions and therefore minimal turbulences are created as the sound passes from the cabinet 10 to airway 14 and to the outside air via hood 16.

FIG. 9 shows a second preferred implementation of the invention where the outer surfaces 36 (FIG. 8) are reconfigured with rounded edges 38 as shown.

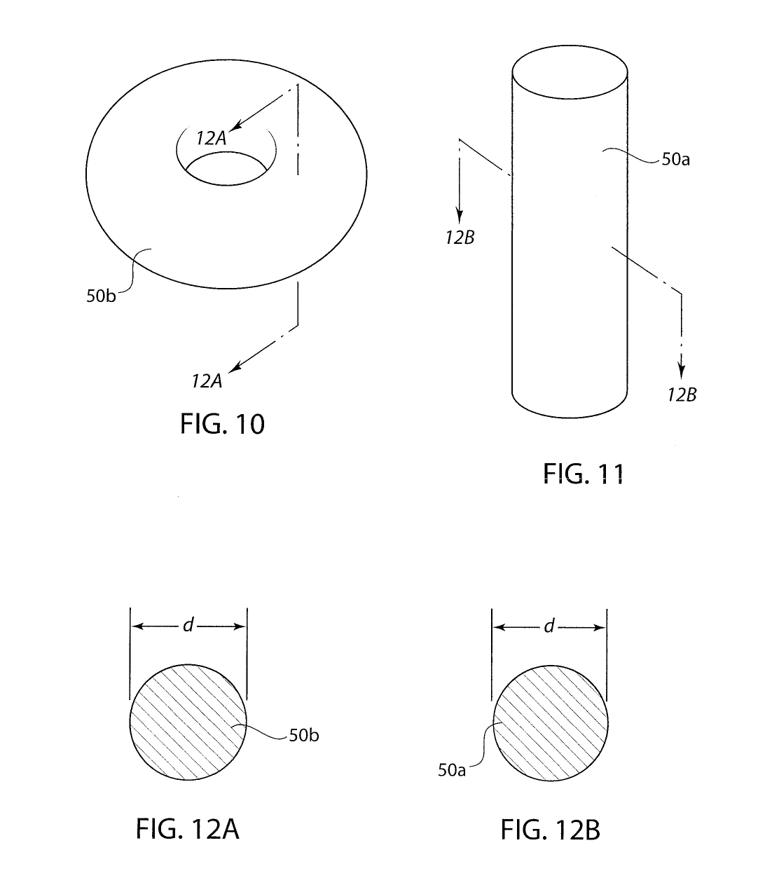

FIGS. 10-12 show examples of the unity volume/unity area of the present invention. FIG. 10 shows an example view of the toroid shaped output sound wave 50b from hood 16, while FIG. 11 shows the cylindrical sound wave 50a as it travels through sound wave path 14, prior to the transition provide by hood 16. FIG. 12 shows the respective cross sections of the toroid sound wave 50b and the cylindrical sound wave 50a of sound wave path 14, showing that they have the same diameter d and therefore are equal in the unity area/volume concept of the present invention. Thus, in the preferred implementation the diameter ratios between the cylindrical sound wave and the transitioned output toroid sound wave would be 1:1.

As mentioned above, in order to achieve this desired effect, all surface within which the sound wave comes into contact must 100% contiguous and be free from any obstructions of any kind, be it right angles, points or sharp interferences within the sound wave path.

In other contemplated embodiments, the above ground hood 16 is connected to the sound wave path and configured to cause the sound wave path to undergo at least a directional change having a magnitude between substantially 90 degrees and substantially 180 degrees before outputting the sound wave into the surrounding environment.

In the instance of a directional change of substantially 90 degrees, a surface placed over, and at a distance above, the output of the cylindrical sound wave port or path 14, would be a substantially flat plane. In this instance of a directional change of substantially 120 degrees, the bowl shaped directional change element would comprise a substantially ⅓ hollow sphere (as opposed to a hollow hemisphere having a substantially 180 degrees of curvature as shown with hood 16).

While there have been shown, described and pointed out fundamental novel features of the present principles, it will be understood that various, omissions, substitutions and changes in the form and details of the methods described and devices illustrated, and in their operation, may be made by those skilled in the art without departing from the spirit of the same. For example, it is expressly intended that all combinations of those elements and/or method steps which perform substantially the same function in substantially the same way to achieve the same results are within the scope of the present principles. Moreover, it should be recognized that structures and/or elements and/or method steps shown and/or described in connection with any disclosed form or implementation of the present principles may be incorporated in any other disclosed, described or suggested form or implementation as a general matter of design choice. It is the intention, therefore, to be limited only as indicated by the scope of the claims appended hereto.

What is claimed is:

1. An underground subwoofer comprising:
an underground cabinet having a sound wave path for carrying sound waves;
a subwoofer element positioned within the underground cabinet and configured to generate sound waves in the direction of the sound wave path; and
an above ground hood connected to the sound wave path and configured to cause the sound wave path to undergo a substantially 180-degree directional change before outputting the sound wave into a surrounding environment

2. The underground subwoofer according to claim 1, wherein said sound wave path is configured to minimize sudden disruption of a sound wave traveling there through by having exclusively smooth transitions throughout the substantially 180 degree directional change of the sound wave path.

3. The underground subwoofer according to claim 1, wherein said above ground hood comprises an underside having rounded internal surfaces positioned over a substantially cylindrical sound wave path:

4. The underground subwoofer according to claim 1, wherein said above ground hood outputs a toroid shaped sound wave having predetermined cross-sectional area.

5. The underground subwoofer according to claim 4, wherein said sound wave path comprises a substantially cylindrical cross section area, said substantially cylindrical cross-section area being equal to the predetermined cross-sectional area of the toroid shaped sound wave.

6. The underground subwoofer according to claim 2, wherein said sound wave path is absent any abrupt transitions and comprises exclusively smooth transitions from the subwoofer element to an exterior opening in the above ground hood.

7. The underground subwoofer according to claim 1, further comprising a transition ratio between the sound wave path and the above-ground hood, said transition ratio being 1:1.

8. The underground subwoofer according to claim 1, further comprising a transition ratio between the sound wave path and the above ground hood, said transition ratio being one selected from a group consisting of 1:1, 1:2, 1:3, 1:4 and 1:5.

9. An underground subwoofer comprising:
an underground cabinet;
a subwoofer element positioned within the underground cabinet and configured to generate sound waves;
a cylindrical sound wave path positioned to receive the sound waves generated by the subwoofer element and carry them upward from the underground cabinet; and
an above ground hood connected to the sound wave path and configured to cause the sound wave path to undergo a substantially 180-degree directional change before outputting the sound wave into a surrounding environment;
wherein the sound wave path is absent any abrupt transitions and exclusively comprises smooth transitions through at least a 90 degree directional change of the sound wave path to carry the sound wave from the underground cabinet to the surrounding environment.

10. The underground subwoofer according to claim 9, wherein said above ground hood comprises an underside having rounded internal surfaces positioned over a substantially cylindrical sound wave path:

11. The underground subwoofer according to claim 9, wherein said above ground hood outputs a toroid shaped sound wave having predetermined cross-sectional area.

12. The underground subwoofer according to claim 11, wherein said cylindrical sound wave path has a cross sectional area, being equal to the predetermined cross-sectional area of the toroid shaped sound wave.

13. The underground subwoofer according to claim 9, wherein said sound wave path is absent any abrupt transitions and comprises exclusively smooth transitions from the subwoofer element to an exterior opening in the above ground hood.

14. The underground subwoofer according to claim 9, further comprising a transition ratio between the cylindrical sound wave path and an output of the above-ground hood, said transition ratio being 1:1.

15. The underground subwoofer according to claim 9, further comprising a transition ratio between the cylindrical sound wave path and an output of the above ground hood, said transition ratio being one selected from a group consisting of 1:1, 1:2, 1:3, 1:4 and 1:5.

16. The underground subwoofer according to claim 9, wherein the directional change of the sound wave from the sound wave path to the above ground hood comprises a directional change of the sound wave path in a range of 90-180 degrees to carry the sound wave from the underground cabinet to the surrounding environment.
